(19) United States
(12) Patent Application Publication
(10) Pub. No.: US 2003/0092476 A1
(43) Pub. Date: May 15, 2003

(54) Gaming system having multiple games of equal value

(75) Inventor: John Fox, Omaha, NE (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(73) Assignee: Stanley E. Fulton, Las Vegas, NV

(21) Appl. No.: 10/290,764

(22) Filed: Nov. 8, 2002

Related U.S. Application Data
(63) Continuation-in-part of application No. 10/230,242, filed on Aug. 28, 2002.
(60) Provisional application No. 60/339,039, filed on Nov. 12, 2001.
(60) Provisional application No. 60/368,483, filed on Mar. 29, 2002.

(51) Int. Cl. A63F 9/24; A63F 13/00; G06F 17/00; G06F 19/00

(52) U.S. Cl. 463/13

(57) ABSTRACT

A method of playing a game is provided which includes the steps of providing a set of locations, betting at least one credit at at least one of the locations, dealing a first set of symbols at a first of the locations, determining a mathematical value for the first set, dealing sets of symbols at all remaining locations, each set having a mathematical value about equal to the mathematical value of the first set, and crediting in accordance with a pay table associated with the value of each location played.

### CROSS-REFERENCES TO RELATED APPLICATIONS

This application is a continuation-in-part application of U.S. application Ser. No. 10/230,242. This utility application claims the benefit of U.S. Provisional Application Serial No. 60/339,039, by John Fox, entitled Video Gaming System filed Nov. 12, 2001 and U.S. Provisional Application Serial No. 60/368,483, by John Fox, entitled Video Gaming System, filed Mar. 29, 2002.

### BACKGROUND OF THE INVENTION

This invention relates to the field of gaming and gambling, and, in particular, to gambling devices such as video gambling devices and other games that offer the player the opportunity to play multiple games on a single game cycle and give the player the choice to pick the games (or game locations) they wish to play at a given time.

Gambling or gaming devices have been in use for decades and were originally introduced in the 19^{th} century. Major advancements in technology of gaming devices occurred when microprocessors were introduced in the field. Advancements were divided into two major segments in their development. The first advancement was mechanical spinning reels and the second was use of “CRT” displays or animated displays of reels, cards, keno boards, and “21” games. The emergence of such microprocessor devices has opened a vast set of possibilities to gambling device designers. U.S. Pat. No. 4,095,795 (Saxton et al.) describes what is believed to be the first microprocessor slot machine.

Another major advancement used microprocessors and a software program to adjust the odds of achieving any particular combination or game outcome. For example, U.S. Pat. No. 4,448,419 (Moody) describes a mechanical reel slot machine controlled by a microprocessor. The software program allowed for the control of the reels and the varying of odds of achieving any particular combination of symbols. Similarly, U.S. Pat. No. 4,711,451 (Pajak et al.) describes a gambling device using mechanical reels but is controlled by a microprocessor.

Microprocessors along with the lowering prices of color monitors allowed the expansion of the second largest area of gambling devices. These devices, known as “Video Games” included video slots, 21, bingo, keno, and poker machines. The largest portion of this segment of the gaming field is the video poker machine.

Historically, video poker has simulated an actual game of cards by using a standard 52 card deck (53 if a joker is used). Thus, the games' payout percentage is controlled by two factors. The number and type of defined winning combinations and the amount that will be awarded if those hands are obtained.

These video poker games would randomly shuffle the deck of cards and deal five cards to the player. The approximate probability of obtaining any of the following winning hands in the initially dealt cards is listed below.

| | |
|---|---|
| Royal Flush | .00015% |
| Straight Flush | .0014% |
| Four of a Kind | .03% |
| Full House | .15% |
| Flush | .2% |
| Straight | .4% |
| Three of a Kind | 2.0% |
| Two Pair | 5.0% |
| Jacks or Better | 12.8% |

However, video poker games provide the opportunity to “hold” or “discard” any number of the player's initially dealt cards and draw new cards from the remaining cards left in the deck. Therefore, the odds of obtaining a winning hand on the draw are dependent on the initially dealt cards, and thus removed from the finite number of cards in the deck. The player can therefore calculate, or make an approximation, of the odds of drawing a winning hand depending on which cards they decide to retain or discard.

The sizes of the awards that are offered on poker machines are a function of two items, the winning combinations and the amount awarded for those combinations. Thus, if a large amount was offered for a Royal Flush with five coins, the amount paid for lesser combinations must be reduced.

U.S. Pat. No. 5,046,735 (Hamano et al.) calculated all possible drawn hands of poker. In U.S. Pat. No. 5,401,023 (Wood), the payable changes with the cards that are being held. This was good for the players but the casinos lost the additional money earned from improper play. U.S. Pat. No. 5,511,781 (Wood et al.) allowed the player to stop the game before the draw and be awarded a higher pay for an existing winning combination. In U.S. Pat. No. 5,785,593 (Wood et al.), the player was allowed to swap the cards used in a particular poker hand. In U.S. Pat. No. 5,868,619 (Wood et al.), players were allowed to re-arrange an existing poker hands into sub hands. U.S. Pat. No. 4,651,997 (Wood) allowed the player to purchase a sixth card to add to an existing five card poker hand. U.S. Pat. No. 5,954,335 (Moody) allowed the player to play multiple 21 hands on the video screen that were duplicated from the first band dealt. U.S. Pat. No. 5,823,873 (Moody) offered the player the opportunity to play two or three hands that were duplicated from the first hand dealt. U.S. Pat. No. 5,816,916 (Moody) increased the number of hands that could be played to five hands that were dealt from a single deck. Again these hands were duplicated from the first hand dealt. U.S. Pat. No. 5,531,448 (Moody) and U.S. Pat. No. 5,489,101 (Moody) gave the players the opportunity to play a three or five card hand using a community set of cards of either six or eight cards that were used by all the players.

U.S. Pat. No. 6,019,374 (Breeding) allows a player to make multiple bets on a single hand and additionally allows the player to withdraw a portion of those bets during game play. In U.S. Pat. No. 6,007,066 (Moody), the device is for a card game that has at least two to “X” rows of card hands. The player then determines which cards to hold in a specific hand and those hold cads are duplicated in all the other hands. The cards held would be displayed in the same positions in all the other hands in a vertical display. The game could draw all the replacement cards from a single deck or use a different deck for each row of cards. It also allows a player to see one of the dealt hands before the player bets on any additional hands that are offered. It also allows the option of displaying a different number of cards or amount of hands and allows the player the option to bet on those hands after the deal. U.S. Pat. No. 5,868,618 (Netley et al.) describes a device that allows a two-tiered poker game that displays two separate poker hands to the player, and are displayed in different colors on the video display. If the first hand is won, the player is allowed to wager that bet on the second hand. U.S. Pat. No. 5,839,731 (Feola) describes a method of play that includes dealing a multiple amount of hands and allowing the player to bet on the hand they believe will be the winning hand. U.S. Pat. No. 5,823,873 (Moody) describes a method of play that allows two or three rows of poker hands to be displayed on the screen. The player is allowed to place a wager on one or all three hands after the hands are dealt face up. The player then selects the cards that their want to hold from the first band and those cards are duplicated to all the other hands that have bets wagered on them. Then replacement cards are dealt to each hand and payouts are awarded to those hands that end with hands that are classified as winning poker hands. U.S. Pat. No. 5,816,916 (Moody) deals an initial five-card poker hand, and the cards are displayed in five locations. Any matching cards in the first hand are stacked together in a pile and replacement cards are dealt to replace the missing cards. This process continues until there are no matching ranks within the hand. The player then decides which cards to hold or discard. Replacement cards are dealt to those card locations that were discarded. At that time, the hands are evaluated to determine what hands have achieved winning combinations.

U.S. Pat. No. 5,732,950 (Moody) describes a card game that displays up to three five-card hands. Each of the five-card hands are formed into a “21” and stud poker hand with bets on each. Awards are paid for each of the hands within a given hand group if certain conditions have been achieved. U.S. Pat. No. 5,697,614 (Potter et al.) describes a card game that may be played against a banker's hand or a predetermined payout schedule. The player receives an initial hand and decides which of a set of hand ranking rules they will play the hand against. U.S. Pat. No. 5,660,393 (Dreger) describes a multiple wager game that is played by a dealer and player. The three dealer's cards and the two player's cards form a hand. The player can place a wager on the first card of the dealers. That card must fall within a predetermined range of cards. Once the dealer's second card is revealed, the player has the option of withdrawing the second wager. U.S. Pat. No. 5,544,892 (Breeding) is a multi-tiered wagering game that consists of an initial bet and an optional second bet. The dealer receives two cards and the player receives three cards. The player is now given the option to remove one part of his bet. After the first card is exposed, the player may remove a second portion of his bet. After the dealer's second card is exposed, the wagers are resolved. There is also an option of have a bonus jackpot for the second bet.

U.S. Pat. No. 5,816,915 (Kadlic) allows a multi hand game. This game would use four hands, with two cards being dealt face up and three cards dealt face down. The player would then select the hand they wish to play. The player may then hold or discard any cards they wish to in the hand and a payoff is awarded for certain hand combinations.

All references cited herein are incorporated herein by reference in their entireties.

### BRIEF SUMMARY OF THE INVENTION

A method of playing a card game is provided which includes the steps of providing a video display, providing an attract screen that includes a list of selectable card games, providing a game screen that includes several card hand locations, and selecting one of the selectable card games for each of the card hand locations (or selecting a prearranged group of card hands or using the groups that are predetermined by machine). The method further includes providing a means to bet at least one credit at each of the card hand locations, dealing a first hand of cards at a first of the card hand locations from a first deck of cards and determining a mathematical value for the first hand of cards based on the probability and amount of potential payoff. The method then includes the step of dealing hands of cards at all remaining card hand locations with each hand having cards from a separate (or a subset of a) deck of cards (or like display) and each hand (or like display) having a mathematical value equal to or greater than the mathematical value of the first hand (or like display). The method then allows the player to hold and draw cards in accordance with the selected card game. Finally, the player is paid in accordance with a pay table associated with the value of each hand played. Optionally, the player may select one or more of the hands of cards to continue play after all hands are dealt, and the player may move the bet associated with each hand to the selected one or more other hands.

In a first preferred embodiment of the present invention, a method of playing a card game is provided which includes the steps of providing a plurality of card hand locations, betting at least one credit at at least one of the card hand locations (at a minimum, only one credit at one card location need be bet), dealing a first hand of cards at a first of the card hand locations from a deck of cards, determining a mathematical value for the first hand of cards, dealing hands of cards at all remaining card hand locations, each hand having a mathematical value about equal to the mathematical value of the first hand, and crediting the player in accordance with a pay table associated with the value of each hand played.

Preferably, a video display is provided. The initial screen on the video display may include a plurality of selectable card games. The player may select one of the plurality of selectable card games for each of the card hand locations. Preferably, each hand is dealt from a separate deck of cards. Subsequent to betting and dealing all the hands, the player may hold and draw cards for each selected card game.

Optionally, after dealing all of the hands and prior to holding and drawing cards, a player may select at least one of the hands of cards for continued play (and abandon the other hands). Here, the player may move the bet from the nonselected hands to the selected one or more hands.

In an another preferred embodiment of the present invention, a method of playing a card game is provided which includes the steps of providing a plurality of card hand locations, betting at least one credit at at least one each of the card hand locations (again, at a minium only one credit at only one card location need be bet), dealing a first hand of cards at a first of the card hand locations from a deck of cards, determining a mathematical value for the first hand of cards for each of a plurality of winning combinations, dealing hands of cards at all remaining card hand locations, determining a mathematical value for each hand at all remaining card hand locations for each of a plurality of winning combinations, assigning a potential award value to the first hand of cards for each type of winning combination, determining an award card factor for each type of winning combination in the first hand by multiplying the potential award value for each type of winning combination for the first hand of cards by the mathematical value for each type of winning combination for the first hand of cards, dividing the award card factor for each type of winning combination by the mathematical value for each type of winning combination associated with each remaining card hand location to determine a set of potential award values for each remaining card hand location which correspond to each type of winning combination, providing an award card table for each hand where the award card table lists the set of potential award values for each hand, and crediting the player in accordance with the award card table associated with the value of each hand played.

In another embodiment of the present invention, a method of playing a card game is provided which includes the steps of providing a plurality of card hand locations, betting at least one credit at at least one of the card hand locations (again, at a minimum, only one credit at one card location need be bet), dealing a first hand of cards at a first of the card hand locations from a deck of cards, determining a mathematical value for the first hand of cards for each of a plurality of winning combinations, dealing hands of cards at all remaining card hand locations, determining a mathematical value for each hand at all remaining card hand locations for each of a plurality of winning combinations, and crediting in accordance with a pay table associated with the value of each hand played such that the mathematical value of the first hand multiplied by an award for each winning combination in the first hand is equal to the mathematical value of each remaining hand times an award for each winning combination.

In another embodiment of the present invention, a method of playing a card game is provided which includes the steps of providing a video display, providing an initial screen that includes a plurality of selectable card games, providing a game screen that includes a plurality of hand locations, selecting one of the plurality of selectable card games for each of the card hand locations, betting at least one credit at at least one of the card hand locations (again, at a minimum, only one credit at one card location need be bet), dealing a first hand of cards at a first of the card hand locations from a deck of cards, determining a mathematical value for the first hand of cards, dealing hands of cards at all remaining card hand locations, each hand having a mathematical value about equal to the mathematical value of the first hand, holding and drawing cards in accordance with each selected card game; and crediting the player in accordance with a pay table associated with the value of each hand played.

In another preferred embodiment of the present invention, a method of playing a card game is provided which includes the steps of providing a video display, providing an initial screen that includes a plurality of selectable card games, providing a game screen that includes a plurality of hand locations, selecting one of the plurality of selectable card games for each of the card hand locations, betting at least one credit at at least one of the card hand locations (again, at a minimum, only one credit at one card location need be bet), dealing a first hand of cards at a first of the card hand locations from a deck of cards, determining a mathematical value for the first hand of cards for each of a plurality of winning combinations, dealing hands of cards at all remaining card hand locations, determining a mathematical value for each hand at all remaining card hand locations for each of a plurality of winning combinations, assigning a potential award value to the first hand of cards for each type of winning combination, determining an award card factor for each type of winning combination in the first hand by multiplying the potential award value for each type of winning combination for the first hand of cards by the mathematical value for each type of winning combination for the first hand of cards, dividing the award card factor for each type of winning combination by the mathematical value for each type of winning combination associated with each remaining card hand location to determine a set of potential award values for each remaining card hand location which correspond to each type of winning combination, providing an award card table for each hand, the award card table listing the set of potential award values for each hand; and crediting the player in accordance with the award card table associated with the value of each hand played.

In yet another preferred embodiment of the present invention, a method of playing a card game is provided which includes the steps of providing a video display, providing an initial screen that includes a plurality of selectable card games, providing a game screen that includes a plurality of hand locations, selecting one of the plurality of selectable card games for each of the card hand locations, betting at least one credit at at least one of the card hand locations (again, at a minimum, only one credit at one card location need be bet), dealing a first hand of cards at a first of the card hand locations from a deck of cards, determining a mathematical value for the first hand of cards for each of a plurality of winning combinations, dealing hands of cards at all remaining card hand locations, determining a mathematical value for each hand at all remaining card hand locations for each of a plurality of winning combinations, and crediting in accordance with a pay table associated with the value of each hand played such that the mathematical value of the first hand multiplied by an award for each winning combination in the first hand is equal to the mathematical value of each remaining hand times an award for each winning combination.

In yet another preferred embodiment of the present invention, a method of playing a card game is provided which includes the step of providing a plurality of card hand locations, betting at least one credit at at least one of the card hand locations (again, at a minimum, only one credit at one card location need be bet), dealing hands of cards at each card hand location, selecting at least one hand of cards for continued play, holding and drawing cards for each card game selected for continued play, and crediting the player in accordance with a pay table associated with the value of each hand played.

In still another preferred embodiment, a method of playing a game is provided which includes the steps of providing a plurality of first symbols and a plurality of second symbols, providing a first play location having a plurality of first play location spaces for displaying a subset of the first symbols and providing a second play location having a plurality of second play location spaces for displaying a subset of the second symbols. The method further includes the steps of betting at least one credit at each of the first play location and the second play location and randomly assigning and displaying one symbol of the first symbols to a plurality of the first play location spaces, but not to all of the first location spaces, and determining a mathematical value based on the randomly assigned and displayed symbols that is based on odds of achieving a specific subset of symbols of the first symbols when every first play location space is assigned and displayed one of the first symbols. The method additionally includes the step of assigning and displaying one symbol of the second symbols to a plurality of the second play location spaces, but not to all of the second location spaces, wherein the mathematical value of the assigned and displayed second symbols is substantially the same as the mathematical value of the randomly assigned and displayed first symbols. First symbols are randomly assigned and displayed in each first play location space that has not yet been assigned and displayed one of the first symbols and second symbols are randomly assigned and displayed in each second play location spaces that has not yet been assigned and displayed one of the second symbols. Finally, the player is credited in accordance with a pay table associated with the value of the subset of symbols for each play location.

A method of playing a game is also provided which includes the steps of providing a plurality of first symbols and a plurality of second symbols, providing a first play location having a plurality of first play location spaces for displaying a subset of the first symbols and providing a second play location having a plurality of second play location spaces for displaying a subset of the second symbols, betting at least one credit at each of the first play location and the second play location, and randomly assigning and displaying one symbol of the first symbols to a plurality of the first play location spaces, but not to all of the first location spaces. The method further includes the step of determining a first mathematical value based on the randomly assigned and displayed symbols that is based on odds of achieving a specific subset of symbols of the first symbols when every first play location space is assigned and displayed one of the first symbols and the step of randomly assigning and displaying one symbol of the second symbols to a plurality of the second play location spaces, but not to all of the second location spaces. A second mathematical value is determined based on the randomly assigned and displayed second symbols that is based on odds of achieving a specific subset of symbols of the second symbols when every first play location space is assigned and displayed one of the second symbols. First symbols are randomly assigned and displayed in each first play location space that has not yet been assigned and displayed one of the first symbols and second symbols are randomly assigned and displayed in each second play location spaces that has not yet been assigned and displayed one of the second symbols. A potential award value is assigned to the first play location for a winning combination. An award card factor is determined or otherwise calculated for the winning combination by multiplying the potential award value by the first mathematical value. The award card factor is divided by the second mathematical value to determine a potential award value for the second play location. The player is credited in accordance with a pay table associated with the value of the subset of symbols for each play location.

In yet another (broad) description of the preferred embodiment, a method of playing a game is provided which includes the steps of providing a plurality of first symbols and a plurality of second symbols, providing a first play location having a plurality of first play location spaces for displaying a subset of the first symbols and a second play location having a plurality of second play location spaces for displaying a subset of the second symbols, betting at least one credit at at least one of the first play location and the second play location, randomly assigning and displaying one symbol of the first symbols to a plurality of the first play location spaces, determining a mathematical value based on the randomly assigned and displayed symbols that is based on odds of achieving a specific subset of symbols of the first symbols when every first play location space is assigned and displayed one of the first symbols, and assigning and displaying one symbol of the second symbols to a plurality of the second play location spaces. The mathematical value of the assigned and displayed second symbols is substantially the same as the mathematical value of the randomly assigned and displayed first symbols.

While just two hands are indicated in this embodiment, it is intended that more than just two hands may be displayed such that mathematical values could be applied in a similar manner to multiple hands.

Finally, a method of playing a game is provided which includes the steps of providing a plurality of first symbols and a plurality of second symbols, providing a first play location having a plurality of first play location spaces for displaying a subset of the first symbols and a second play location having a plurality of second play location spaces for displaying a subset of the second symbols, betting at least one credit at at least one of the first play location and the second play locations, randomly assigning and displaying one symbol of the first symbols to a plurality of the first play location spaces, determining a first mathematical value based on the randomly assigned and displayed symbols that is based on odds of achieving a specific subset of symbols of the first symbols, randomly assigning and displaying one symbol of the second symbols to a plurality of the second play location spaces, determining a second mathematical value based on the randomly assigned and displayed second symbols that is based on odds of achieving a specific subset of symbols of the second symbols, assigning a potential award value to the first play location for a winning combination, determining an award card factor for the winning combination by multiplying the potential award value by the first mathematical value, and dividing the award card factor by the second mathematical value to determine a potential award value for the second play location.

Again, while just two hands are indicated in this embodiment, it is intended that more than just two hands may be displayed such that mathematical values could be applied in a similar manner to multiple hands.

There are a wide variety of steps that may be taken by the player that manipulate the features offered to the player using the mathematical values of one hand applied to one or more other hands as a basis. One instance is moving the credits bet, as described above. Another instance is that the player may re-spin a selected slot reel or be redealt a card, etc. Another instance is the player may be offered another bonus card or slot symbol. These are just examples.

### BRIEF DESCRIPTION OF SEVERAL VIEWS OF THE DRAWINGS

The invention will be described in conjunction with the following drawings in which like reference numerals designate like elements and wherein:

FIG. 1 is a front elevational view of a video gaming system in accordance with one preferred embodiment of the present invention.

FIG. 2 is an initial “attract” screen of the video gaming system of FIG. 1.

FIG. 3 is a button deck for use with the video gaming system of FIG. 1.

FIG. 4 is a game screen of the video gaming system of FIG. 1.

FIG. 5 is a game screen of an alternative embodiment of a video gaming system in accordance with another preferred embodiment of the present invention.

### DETAILED DESCRIPTION OF THE INVENTION

A first preferred embodiment of the present invention is a modification of conventional electronic video poker. In the basic form of conventional video poker, the player is dealt five cards all face up from a single fifty-two card deck. The player selects which cards to hold and discards the unwanted cards. Replacement cards are dealt from the same fifty-two card deck for the discarded cards and the player has a final five card hand. This hand is compared to a pay table based on conventional poker hand ranking. If the player has a winning hand, he receives an award based on the number of coins, tokens or credits wagered by the player.

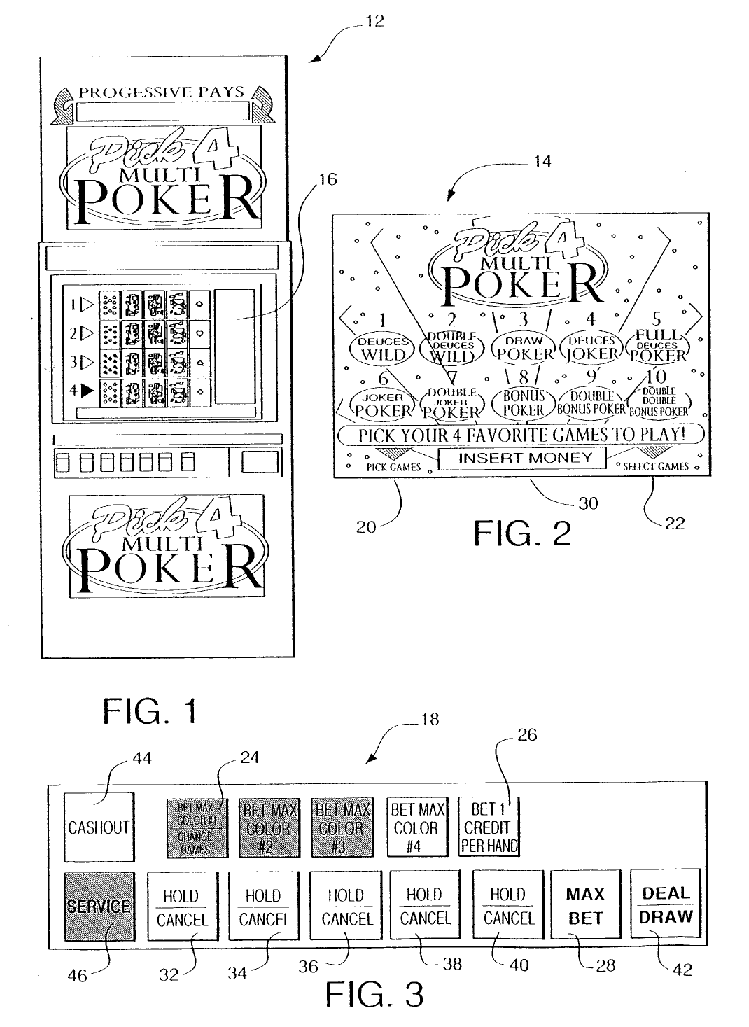

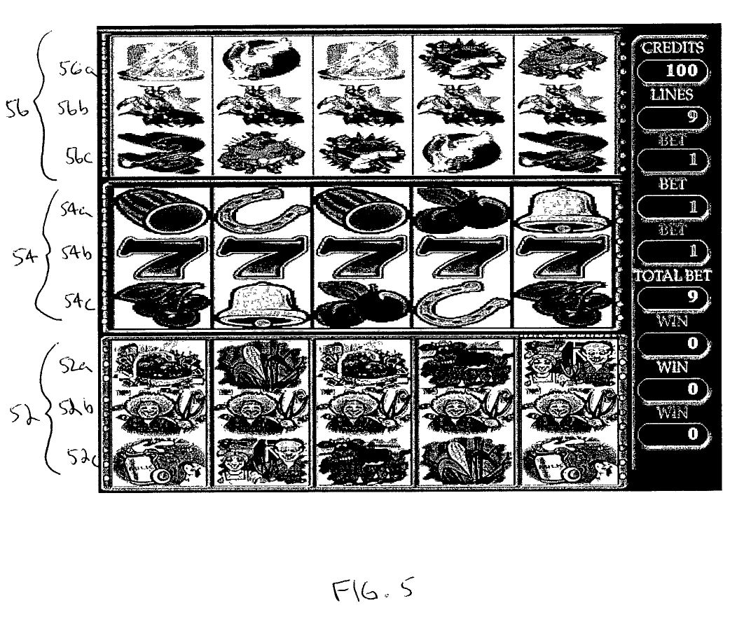

Referring now to the drawings, wherein like part numbers refer to like elements throughout the several views, there is shown in FIG. 1, a video gaming system 12 in accordance with one preferred embodiment of the present invention. The system 12 preferably has an “attract” screen 14, as shown in FIG. 2, to attract a player to approach the system 12. This attract screen 14 may depict, for example, ten games, designated 1-10 on the screen of FIG. 2, that the player may select from to play. Of course, the attract screen 14 could have greater than or less than ten games to select from (or the games can be preselected in groups selected by a computer program). For example, the screen could have as few as one game (however, for this type of game, no selection need be made), to as many as twenty or more games (not shown). Additionally, while the attract screen 14 of FIG. 2 depicts ten different poker games, for example, “deuces wild”, “joker poker”, “bonus poker”, and the like, substantially any type of poker game or other similar and suitable card game used in the video gaming industry could be utilized in the present invention. Additionally, as will be described below with respect to an alternate embodiment, any nonpoker game using symbols may also be displayed. Therefore, the term “hands” may generally apply to any game using symbols such as a slot machine display. The attract screen 14 allows a player to make his or her selections of, for example, his or her four favorite games to be displayed on a game screen (see FIGS. 1 and 4) (these games could also be displayed in pre-arranged groups or preselected by the computer program). While FIGS. 1 and 4 depict a video gaming system 12 having four hands, it is anticipated that the present invention can accommodate as few as two hands and as many hands as could reasonably fit on a screen, for example, twenty hands.

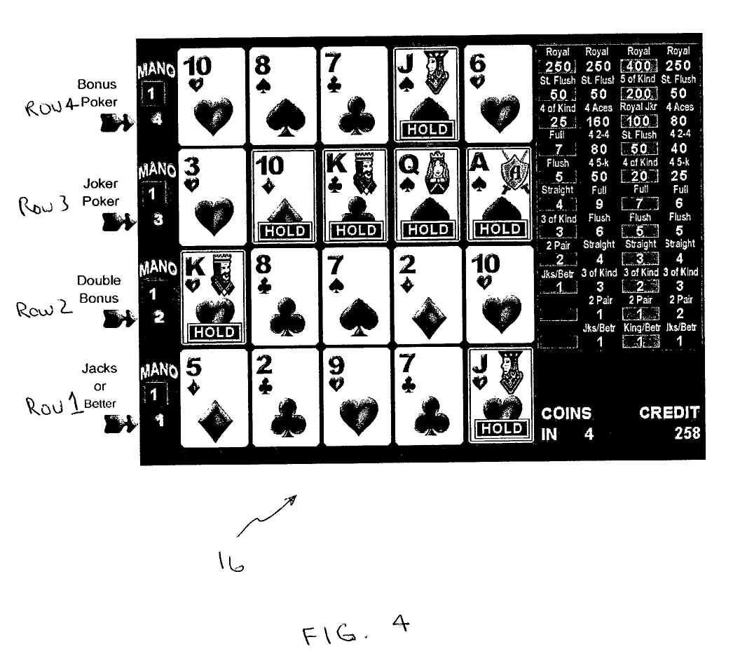

The player will then use various buttons on the button deck 18 (see FIG. 3) associated with the video gaming system 12 to select the game or games that he or she wishes to play. It is noted that each button on the button deck 18 may serve to initiate one, or more than one, function. For example, the attract screen 14 or game screen 16 may have an icon that points to one or more buttons on the button deck 18 for the player to use to perform a particular function. Additionally, during different points in the play, a single button may be associated with different functions wherein other functions associated with that function are disabled. It is noted that the video display screen, as shown, can be a touch screen, as well known in the art. Therefore, this touchscreen may be used alone in lieu of the button deck or in combination with the button deck 18.

In the preferred embodiment, the player is not required to play the number of hands the video gaming system 12 is capable of displaying. For example, if the video gaming system 12 is capable of displaying ten hands, the player may select, for example, only three hands to play. The video gaming system 12, as shown in FIGS. 1 and 4 depicts four hands.

The games to be played are now selected. A “pick games” button, for example, a button below the “pick games” icon 20 on the attract screen 14, may move highlighting or a cursor to associate the pick games icon 20 with one particular game displayed. By depressing the button associated with the “pick games” icon 20, each different game will be sequentially highlighted. A button associated with “select games” icon 22 will allow the player to make the selection of the game or games he or she wishes to play and be displayed on the game screen 16 (to be discussed below). Once all of the games desired to be played have been selected, the video gaming system 12 moves to the game screen 16 with newly dealt hands displayed at hand locations. At this point, the hands are not shown. As mentioned previously, these hands could be preselected in various ways already described.

Alternatively, the video gaming system 12 can omit the game selection feature, as described above. Here, the system 12 would be preloaded with two or more games. These games may be identical, e.g., four hands of “deuces wild” poker, or they may have one or more different games that are preloaded. Also, alternatively, all the hands may be the same preloaded game. Alternatively, the games may be a preloaded game set that may or may not be selectable.

When the attract screen 14 transitions to the game screen 16 (see FIG. 4), the player, at any time, can go back to the attract screen 14 and change his “lineup” of hands, by pressing a “change games” button 24 on the button deck 18. Here, the change games button 24 (which is not otherwise functional during the time the game screen is functional) will act to take the player back to the attract screen 14 to reselect his lineup of games, prior to additional play or to change his lineup after he has been playing. The change games button 24 preferably becomes inoperable after credits have been bet for a game and is reactivated once a set of hands has been played.

The video gaming system 12 is adapted to accept money at any time through a money acceptor in the form of bills into a bill acceptor, coins or tokens into a coin acceptor, credit or debit cards into a card reader, or through biometric transfer from a thumbprint, retina scan digital photo, or the like. A combination of one or more of these forms of payment may also be possible. The player now has “credits” on the game to play and is ready to play. The money may be inserted into the money acceptor during the time the attract screen is displayed or at any time until a point after the lineup of hands has been selected, as described above. The display screen, i.e., the attract screen 14 or the game screen 16, will always display the icon “insert money” 30 to begin play or when credits have been depleted until money has been inserted.

The game screen 16 will indicate credits available on a credit meter. In the preferred embodiment of the present invention, the player can bet, by depressing the “bet one credit per hand” button 26, for example, for the four hands in the embodiment of FIG. 1 shown. The player may continue to push this button 26 until he or she has bet the desired credits, up to the maximum bet per hand. The maximum bet is predetermined in the game software and is preferably not adjustable by the player but by the operator. A system having unlimited betting (or betting as little as 1 credit total and everything in between) is also within the scope of this invention.

When the maximum bet is attained either by betting one credit per hand until the maximum is reached or by hitting the “max bet” button 28, playing the maximum credits all at once, or when betting is otherwise complete, the cards are dealt preferably from the bottom hand, Row 1 up. Pay tables for each of the four hands are displayed to the right of each hand and depend upon the game selected and the percent payback tables in software for each game. The player is preferably required to bet a minimum of one credits on each hand up to a maximum number of credits. Each band preferably (but not absolutely necessarily) must have the same number of credits bet on each hand.

The player hits the draw button (draw/deal button 42) and the cards are dealt and visible face up. Dealing is in accordance with the present invention, as described in detail below. FIGS. 1 and 4 display an example of the game screen 16 which depicts four selected poker hands in Row 1, Row 2, Row 3 and Row 4. Again, the video gaming system 12 of the present invention may display more or less than four hands. After the last game selection is made on the attract screen 14 of FIG. 2, for example, after the fourth game selection is made, the game will preferably automatically transition to the game screen 16. The first hand selected will be placed as the bottom hand, Row 1, and the next three hand selections Row 2, Row 3, and Row 4 will be displayed vertically upward from there.

The player now has the option at this time to play out all four hands, i.e., the hand of Row 1, Row 2, Row 3, and Row 4, or bet all his original bet on one of the four hands selected. Each hand is preferably color coded to make selection easier. For example, Row 1 may be yellow, Row 2 may be purple, Row 3 may be green and Row 4 may be red. Two options here will now be described. In the first option a “bet it all” option, the player will select which of the four hands he wishes to play, by selecting a button designated “Bet Max Color 1” (yellow), “Bet Max Color 2” (purple), “Bet Max Color 3” (green), or “Bet Max Color 4” (red) such that the video gaming system 12 will bet all original credits wagered (that were bet on all hands) and the money will be transferred to the hand selected. The other three hands will disappear. For example, in FIG. 1, a player may select the hand of Row 2. Row 1, Row 3, and Row 4 will disappear from the game screen 16. That is, one set of cards will be on the game screen 16 and the hold buttons 32, 34, 36, 38, 40 will be lit up like a standard video poker game, as known in the art. The player will hold and draw cards in an identical manner to standard poker and be paid according to the pay table displayed. The pay table to the right of the cards will only be displayed for the selected game that the player has decided to play. The player will be paid as in standard poker. If the player wants to cancel this operation, i.e., the player does not want to play the maximum bet on a single hand, the player may, for example, simply push the selected “Bet Max Color” button a second time and the game screen will reappear exactly as the game was originally dealt with the four hands displayed.

Rather than betting the entire amount on the game on a single hand, the player may bet on each hand individually, as follows. Once all four hands of Row 1, Row 2, Row 3, and Row 4 have been dealt, the video gaming system 12 will preferably have a feature that optionally automatically holds the cards for each hand in manner that gives the player the highest mathematical probability of success. This “autohold” feature is common in video poker games. The four hands of Row 1, Row 2, Row 3, and Row 4 will be displayed with the hold selections automatically made for the player. The player can choose to use the autohold for any of the games or cancel or add to these selections at his discretion. The autohold feature can also be used in the embodiment above. The player will use the five hold/cancel buttons 32, 34, 36, 38, 40 to hold additional cards or cancel the autohold selection for each card for each hand played, in a manner as known in the art. The five hold/cancel buttons 32, 34, 36, 38, 40 correspond to the five cards for each game and will cursor up starting at the game on the bottom and move up to each hand until selections for all four hands are completed, and held as desired by the player. The player then presses the “deal/draw” button 42 and the hands will be completed and paid according to the ending result on each pay table just like standard poker, as known in the art.

Optionally, in another embodiment, the player may distribute his wager between all hands depending on which ones the player likes the most or least. For example, if again there are three hands, the player may elect to bet one-half of his wager on the first hand and one-fourth of his wager on each of the second and third hands.

Optionally, in another embodiment, the initial bet may be placed only on the first hand. After the other hands are dealt, the player has the option of moving money to play any or all of the remaining hands or keeping the money bet on the original hand.

The pay tables used by the video gaming system 12 are dynamic and change depending upon the credits bet, the different game types, and the “bet it all” possibility and are (preferably) to the night of the cards. Adjacent to the cards (preferably either to the side or below) are a “credit meter”, a “win meter”, a “credits bet” display, a “game over” icon, “winner paid” meters, a message screen and the like (not shown), as in other video poker systems known in the art. These can change depending on regulations for worldwide use. The game can have progressive capability on any number of different jackpot combinations, as known.

The game will preferably use separate fifty-two card decks for each different hand or separate fifty-three card decks (for, for example, the joker and double joker wild game hands). A “cashout” button 44 and a “service” button 46 (for change and the like), as in standard poker games known in the art may also be included. Payouts can be in the form of a coins, tickets, data input into to debit or credit card, or can be transferred biometrically, or other means known in the art.

The dealing of the hands in accordance with one special aspect of the present invention will now be described in detail. From a first deck corresponding to the game selected for the hand of Row 1, a first hand, i.e., Row 1 is dealt. Every hand of poker has a known or calculatable mathematical value that has a particular probability for a payout of a particular value (e.g., a full house). Once Row 1 is dealt, a group of hands is dealt from separate decks (or subsets of decks or predetermined groups of things with like mathematical values) for each corresponding hand in Rows 2, 3 and 4, etc., based on the cards dealt in Row 1, that yield the mathematical value, as described above, that has approximately the same probability for a like payout as in the hand of Row 1. That is, a hand of cards of a particular mathematical value associated with that of Row 1 is randomly selected to form the hands of Rows 2, 3, and 4. The mathematical values may be based on algorithms, or, more preferably, based on mathematic tables. These values are commonly known in the gaming industry and are mathematically calculated values that reflect the probability of improving that hand based on the award schedule offered to the player. All four hands may be displayed essentially simultaneously. In essence, four hands are displayed, that may or may not look alike, but each hand has (basically) the same mathematical value. This mathematical value may, in actuality, be slightly more, equal to or slightly less than the exact mathematical value. For purposes of the present invention, “about equal to the mathematical value” or “substantially equal to the mathematical value” or a like phrase is intended to include values that are slightly more, equal to, or slightly less than the exact mathematical value, for example, within about one to ten percent. However, the mathematical values are substantially close to one another such that the relative payout to a player would be irrelevant to the player. From here, as described above, the player may individually select the one hand he or she thinks looks the best and transfer his entire wager to that hand, or play each individual hand, as described above. The player may now press the draw button and each one of the hands now being played will receive the replacement cards from the hands' respective separate decks to complete each hand. Winning hands will be paid to the player.

Optionally, the player may be given the opportunity to “cash out” at various points during actual play. For example, after all hands are initially dealt and displayed (during the period when the player may move his redistribute his wager to one or more specific hands), the player may hit a cash-out button. Since a mathematical value is known for the hands, a pay table can be calculated where the player can get back a portion or multiple of his money bet. For example, if a player is dealt three jacks a four and a five, the system can determine a mathematical value for obtaining a better hand, such as four jacks or a full house. If the player cashes out at this point, the value of the award received would be somewhat higher than if the player held the three jacks and draws two new cards, but ends up with only the three jacks. Similarly, if a player is dealt a four, five, six, seven and jack, the system can determine a mathematical value for obtaining a straight (if the player holds the four, five, six and seven and draws one new card), the player may hit the cash-out button and receive a calculated value that is greater than zero credits based on the mathematical value related to potentially hitting a straight.

In yet another similar optional feature, the player may “buy” another chance of receiving one or more cards that are dealt to him. For example, if the player ends up with a hand (after holding and drawing new cards) having three jacks, a two and a three, prior to payout, the player may select, for example, the two, pay a certain number of credits, and obtain a new card for that two. The number of credits required to obtain the new card is again determined by determining the mathematical value of obtaining a better hand, for example, four jacks or a full house. This feature may be played independently on each of the hands currently being played.

Similarly, in a variation of this embodiment, after the cards are initially dealt, but prior to holding (or, alternatively, subsequent to holding) and drawing new cards, the player may select one or more cards in one or more hands to draw again. Here, again, the mathematical value of obtaining a better hand is used to determine the number of additional credits required to be input by the player.

Another option of this invention would be the substitution of other “pictures” or symbols that have basically the same mathematical value as the first “picture” displayed and do not necessarily have to be poker card symbols. They could be, for example, 5 slot symbols or 5 random “prize doors” or combinations of cards and other mathematically similar values. Cards and hands are mentioned throughout this document only as one preferred variety but the present application does not intend to be limited in scope to cards. This will be described in greater detail below.

An alternative embodiment of the present invention will now be described in detail. From a first deck corresponding to the game selected for the hand of Row 1, a first hand, i.e., Row 1 is dealt. As described above, every hand of poker has a known set of mathematical values that is a particular probability for payout of a particular value for each type of winning combination. A winning combination is, for example, a pair, a straight, a flush, a royal flush, etc. Once Row 1 is dealt, a group of hands is dealt from separate decks (or subsets of decks) for each corresponding hand in Rows 2, 3 and 4, etc. A separate pay table, i.e., an “award card” is generated for each hand displayed. The values on the award card give each individual hand essentially the same probability for a like payout as in the hand of Row 1. That is, a hand of cards of a particular set of mathematical values is dealt in Row 1. For example, the set of mathematical values for the hand of Row 1 may be 0.001 chance of obtaining a royal flush, a 0.01 chance of obtaining a straight flush, a 0.05 chance of winning a four of a kind, etc. A hand of cards of a different set of mathematical values is dealt in row 2. A hand of cards of yet other set of mathematical values is dealt in Rows 3 and 4, etc. The award cards equalize the probability for a like payout among all hands dealt. That is, while the set of mathematical values of a subsequent hand may be lower (or higher) than that of the hand of Row 1, the value of the award goes correspondingly higher (or lower) to achieve a net result of having all hands having substantially equal odds for winning a given amount of money for each type of winning combination in a hand.

For example, assume that the hand of Row 1 has a mathematical value of 0.001 for a chance of obtaining a royal flush to win an award of $1,000, a mathematical value of 0.01 chance of obtaining a straight flush with an award of $500, a mathematical value of 0.005 for a chance of obtaining a four of a kind with an award of $250, etc. For purposes of this invention, the value of the royal flush hand is 0.001 multiplied by $1,000 to equal an award card factor value of 1. Now assume that the hand of Row 2 has a mathematical value of 0.002 for a chance of obtaining a royal flush. To achieve a value of this hand equal to the award card factor value of 1, the award card value (1) is divided by the mathematical value of 0.002 which results in a chance to win $500. Like calculations are made for each type of winning combination. For example, as stated above, in the first hand, if the chance of obtaining a straight flush has a mathematical value of 0.01 for an award of $500. The award card factor is 0.01 times 500 or 5. The mathematical value for the chance of obtaining a straight flush in the second hand may be 0.02. The award card value here is 5 which is then divided by the mathematical value of 0.02 which yields a potential award equal to $250. Of course, in this example, the specific mathematical values and award card factors here are simplified numbers for purposes of this explanation. Actual mathematical values of various hands of cards would vary substantially. Similar calculations are made for all sets of winning combinations for all hands played.

In summary, a first hand is dealt which yields a set of mathematical values for each type of winning combination. A potential award value is assigned to each of the different types of winning combinations. An award card value is obtained for each type of winning combination by multiplying its associated mathematical value by its potential award value. Subsequent hands are played each of which has its own set of mathematical values for each type of winning combination. The award card value obtained for the first hand for each type of winning combination is then divided by the mathematical value for each type of winning combination in each subsequent hand to obtain a potential award amount.

Optionally, in this embodiment, the type of five card poker being played, e.g., Deuces Wild, Joker Poker, may be selected prior to the first hand being dealt, immediately subsequent to the first hand being dealt, or subsequent to all hands being dealt. Mathematical values are based on these choices.

Again, here, the values in the award card table may be the same, slightly greater than, or slightly less than the precise number calculated for the first hand.

Optionally, the potential award value for the first hand may be randomly determined by software in the game, may use sequential preprogrammed values, or another similar system may be used.

As indicated above, another option of this invention would be the substitution of other “pictures” that have basically the same mathematical value as the first “picture” displayed and do not necessarily have to be poker card symbols. They could be, for example, 5 slot symbols or 5 random “prize doors” or combinations of cards and other symbols having mathematically similar values. Cards and hands are mentioned throughout this document only as a preferred variety mentioned but the present application does not intend to be limited in scope to cards and hands. The terms “cards” and “hands” may refer to any symbols and sets of symbols arranged for game (respectively). For example, the present invention may apply to a slot machine, and cards, as described above, may be slot machine symbols, and a hand may be one (or more) lines of symbols, hereinafter called a “pay location.” Operation of this embodiment will now be described in further detail.

This optional preferred embodiment of the present invention encompasses the first preferred embodiment (the poker game), but is broader in scope in that the method of playing the poker game, as described above, may be applied to other games, for example, a slot machine type game. In this form, any set of symbols may be used, not just the set of symbols included on the cards of a deck of cards. The player first makes a bet for, for example, play at four play locations (a “play location” is analogous to the a “hand” of cards as described above). Of course any number of play locations may be used, as described above with respect to the poker game. Here, the player is shown or displayed, for example, four of six symbols at a first play location. Here, rather than being displayed, for example, five cards in the poker embodiment of this invention above, only four symbols are displayed. If this is a configured as a slot machine type game, the two symbols that are not displayed can be kept “spinning” without landing on a final value, i.e., they are not visible to the player. Based on the four symbols shown, a mathematical value is determined that is equal to the odds of achieving a certain combination of symbols when all six symbols are displayed. Again, as in the poker game embodiment as described above, there may also be several additional play locations, for example, three play locations in addition to the first play location, where each play location has an identical or different game with each play location having its own set of symbols. Again, this is analogous to the poker game as described above. The mathematical value is used when generating the symbols for the additional play locations such that each additional play location displays, for example, four of six symbols, such that the additional play locations each have the same odds for winning the same amount of money as that of the first location. The player may then, as in the poker embodiment described above, move his bet from each of the four play locations to concentrate the bet on one or more desired play locations. The remaining two symbols are displayed for all play locations where there is a bet in place and the player is awarded credits based on a pay table that is based on odds of achieving various combinations of symbols at each play location. This preferred embodiment will now be described in further detail.

Here, a method of playing a game is provided where, first, a plurality of first symbols is provided. As above, these first symbols may be the symbols of a deck of cards and the game may be a poker game as described above, but the symbols may also be, for example, slot machine symbols (for a slot machine type game), or a set of substantially any other types of symbols, for example a set of animal symbols which includes, for example, seventy-five symbols having one of twenty-five different animals. A first play location is now provided. The first play location may be the card hand locations in a video poker game, as described above, or any other location having a set of spaces. For purposes of the present description location “spaces” are analogous to a single card space in a hand of cards, as described above. These spaces are for displaying a subset of the first symbols. Again, these may be a poker hand, a slot machine type display, or a any other set of symbols (such as the animal symbols described above). A second play location must also be provided that, similar to the first play location, displays a subset of second symbols. More play locations may also be provided, however, for purposes of the present invention, the game will generally be described with two play locations. The second symbols may be identical to the first symbols or may be entirely different for play of an entirely different game. Again, this is analogous to playing different types of poker hands, for example “joker poker” and “deuces wild” or it may be, for example, a poker hand in combination with a slot machine style display of symbols. As indicated, third, fourth and fifth and more play locations may also be provided, but the operation in describing two play locations is substantially identical. Now at least one credit, for example, one quarter, is bet at each hand location. For purposes of the present example, one quarter is bet on the first play location and one quarter is bet on the second play location. Of course, if there are more than two hand locations, one quarter could be bet on each of these additional play locations.

Next, here we will assume that there are six first play location spaces where symbols may be located. Of course, a greater number or a lesser number of play location spaces may be provided and the different play locations may each have different numbers of play location spaces. One symbol from the plurality of first symbols is randomly assigned and displayed in at least one, but less than all of the first location spaces. Here, we will assume four symbols are displayed.

A mathematical value is then determined, by, for example, calculation or table, based on the randomly assigned and displayed symbols. This mathematical value is based on the odds of achieving a specific subset of symbols of the first symbols when every first play location space is assigned and has displayed one of the first symbols. In the example here, four symbols out of six are displayed. Given the number of symbols (for example, 52 different symbols in a deck of cards or 25 different animal symbols), a mathematical value can be calculated or otherwise determined for achieving, for example a “straight” for the cards, or, for example, three penguins in a game using animal symbols. These calculations for various combinations of symbols in poker games and for combinations of symbols, for example slot machine symbols, are well known in the art and, therefore, will not be described in detail here.

For the second play location, a plurality of second symbols is provided. These symbols may be the same as the symbols used in the first play location or may be entirely different. In fact, the second play location may have fewer or a greater number of play location spaces, so long as a mathematical value for the second play location may be calculated that is about equal to the mathematical value for the first play location that was previously calculated.

In the second play location, one symbol of the second symbols is assigned to and displayed on each of a plurality of the second play location spaces, but not on all of the second location spaces. The symbols assigned need not be the same as the symbols assigned to the first play location. However, the mathematical value of the assigned and displayed second symbols are substantially the same as the mathematical value of the randomly assigned and displayed first symbols.

Now, in the present example, there are two play locations wherein the mathematical value calculated for the symbols displayed in each play location are substantially the same for each play location. Again, if there are more than two play locations, the symbols for each play location would have the same mathematical value. If desired, as analogous to the poker game embodiment above, the player may now move his or her bet from the bet's original position (for example, one quarter at each play location) to any other play location. For example, if four play locations are played in which one quarter is bet at each location, a player may move all four quarters to a single play location such that one dollar is bet on, for example, the second play location. See the poker game embodiment above for further detail and examples.

In a variation, the player may pay credits to “buy” a chance to re-spin one or more selected play location spaces to obtain one or more new symbols, after the first, for example four of six symbols are displayed, but prior to all six symbols being displayed. For example, if the player receives two cherries, a bar and a space, and has two spaces that remain spinning, the player may select, for example, the bar, pay a certain number of credits, and obtain a new spin for that space. The number of credits required to obtain the new spin is again determined by determining the mathematical value of obtaining a better set of symbols, for example, three cherries. This feature may be played independently on each of the play locations currently being played. Here, again, the mathematical value of obtaining a better hand is used to determine the number of credits required to be input by the player. Again, these mathematical values are easily determinable by one skilled in the art.

Next, first symbols are randomly assigned and displayed in each first play location space that has not yet been assigned and is not yet displaying one of the first symbols. In the example here, two spaces do not yet have symbols displayed. Likewise, second symbols are randomly assigned and displayed in each second play location spaces that has not yet been assigned and is not yet displaying one of the second symbols. If there are additional play locations, symbols are randomly assigned and displayed in a similar fashion.

In another variation, the player may “buy” another chance of receiving a different one or more symbols than that assigned and displayed at the end of a typical game. For example, if the player ends up with a pay location having two cherries, a bar, a space and two horseshoes, prior to payout, the player may select, for example, the bar, pay a certain number of credits, and obtain a new spin for that space. The number of credits required to obtain the new spin is again determined by determining the mathematical value of obtaining a better set of symbols, for example, three cherries. This feature may be played independently on each of the play locations currently being played.

Finally, the player is credited in accordance with a pay table associated with the value of the subset of symbols for each play location.

As in poker embodiment described above, there may be many mathematical values associated with a set of displayed symbols at a play location. For example, if three of five cards are displayed, there may be 0.01 chance of achieving a royal flush (that will be awarded a certain number of credits), a 0.03 chance of achieving a flush (that will be awarded a different, lower, number of credits), a 0.08 chance of achieving a straight (that will be awarded a different, still lower, number of credits), etc. The operation of the present embodiment is intended to include such multiple mathematical values. The description as indicated above with respect to a single mathematical value applies to a play location having multiple mathematical values. Here, each play location must take into account all such multiple mathematical values when equalizing the mathematical values. In the example stated above, the second play location must have 0.01 chance of achieving one award, 0.03 chance of achieving a second award, 0.08 chance of achieving a third award, etc. However, the 0.01 chance of achieving one award may be, for example, the based on the chance of achieving four cherries in a slot machine type game, the 0.03 chance may be for achieving two bars, etc.

At the beginning of a game, the player may select one of several selectable games for each of the play locations. See the above poker embodiment for an analogous example.

An example using a simple four slot-machine style games will now be given. A set of twenty slot symbols is used for the each of a first play location, a second play location and a third play location. Each of the play locations has five play location spaces with each space capable of displaying forty random slot symbols that are made up of the set of 20 slot symbols. The symbols need not be identical among play locations. For example, the first and second play locations may use animal symbols and the third and fourth play location may use standard slot symbols. Prior to play, the player may select the type of game (animals, slot symbols, joker poker, etc.) at each play location in an analogous manner to that described above with respect to the preferred poker embodiment.

The player then spins the slot reels by, for example, pressing a button. Three (of the five) symbols are randomly selected and displayed at the first play location. The other two spaces at the first play location are kept spinning. One or more mathematical values may then be calculated or otherwise determined for the chances of winning various awards. For example, if the first play location displays two penguins and a lion, mathematical values may be determined for achieving each of three penguins, four penguins, a pair of penguins and a pair of lions, etc. This set of mathematical values is then used to select and display three symbols at each of the second, third and fourth play locations such that the odds for winning an award of a certain number of credits is substantially the same for each of the play locations. Therefore, in the present example where a pair of penguins and a lion were displayed, where there is a chance of winning, for example, ten dollars based on a one quarter bet if the player ends up with three penguins when symbols at all five spaces are displayed, the second, third and fourth play locations each display three playing card symbols that yield a like mathematical value such that, for example, the mathematical value of obtaining a full house at the second play location (to obtain an award of ten dollars) is the same as the mathematical value for obtaining three penguins at the first location.

At this point, there are four play locations each displaying three of five symbols. The other two spaces are kept “spinning.” Each play location has substantially the same mathematical value based on the displayed symbols. Now, the remaining spaces at each play locations are each randomly assigned a symbol from that play location's set of symbols. Each play location now has five symbols shown which are then compared to an award table. For example, two penguins in the first play location is awarded two dollars, three penguins in the first play location is awarded ten dollars, a pair of jacks in the second play location is awarded two dollars, and a straight in the second play location is awarded ten dollars (because, for purposes of the present example, the mathematical value of three penguins (for achieving an award of ten dollars) in the first hand is the same as the mathematical value of a straight in the second hand (for achieving an award of ten dollars) is substantially the same and the mathematical value of two penguins (for an award of two dollars) in the first hand is the same as the mathematical value.

A variation of this preferred embodiment is as follows. This variation is analogous to a variation as described above with respect to the poker game embodiment and operates substantially in the same manner. It is only described briefly here for clarity sake. As in the above embodiment, in this variation, a first set of symbols is displayed having a first mathematical value (or set of mathematical values). However, rather than equalizing the mathematical values of the second hand location, third hand location, etc. by predetermining the symbols, symbols are randomly displayed and assigned (for example, three of five symbols for all hand locations are randomly displayed and assigned). A mathematical value (or set of mathematical values) is then determined or otherwise calculated for each player location. Therefore, each play location has a different set of three of five symbols displayed, each having its own mathematical value(s). Bets may be moved around from play location to play location as indicated above with respect to the poker game embodiment.

A potential award value is assigned to the first play location for a winning combination or set of winning combinations. For example, three penguins has a potential award value of six dollars per dollar bet at the first play location. Here, for example, three penguins has a mathematical value of 0.1. An award card factor for the winning combination is determined by multiplying the potential award value (six dollars per dollar bet) by the first mathematical value (0.1) to equal an award card factor of 0.6 per dollar bet. This award card factor (0.6) is divided by the mathematical value of achieving a full house at the second play location of, for example, 0.05 based on, for example, three symbols displayed. This would yield a potential award value for the second play location of twelve dollars per dollar bet (0.6/0.05=12) for achieving a full house.

Symbols are randomly displayed and assigned at the two spaces in each of the play locations that has not yet received a symbol to yield a final set of symbols at each play location upon which an award will be based.

The player is then credited in accordance with a pay table. For example, the player may have selected to move his entire bet (from, for example, one quarter, at each play location) to all four quarters at the second play location. The player has assigned and displayed a full house. He has bet one dollar at the second play location which is multiplied by the potential award value twelve dollars per dollar bet. Therefore, the player is credited twelve dollars. Again further details may be seen above with respect to the poker game embodiment.

In another variation of this embodiment, the player may have the ability to hold and draw new symbols. This is essentially analogous to the poker embodiment described above, but may apply to any set of symbols whatsoever. For example, in a six reel slot machine style game, six of six symbols are originally displayed at a first play location. The player will have the ability to discard and re-spin, for example up to three symbols. A set of mathematical values can be determined based on the chance for obtaining one or more sets of symbols. Additional sets of symbols having about the same mathematical value is displayed at additional play locations. Bets may be moved, combined, etc, as described above in the poker embodiment. The player discards and re-spins the selected locations and is paid accordingly.

An example of a game screen 50 for a slot machine in accordance with this embodiment of the present invention is depicted in FIG. 5. Here, the game screen 50 has three sets 52, 54, and 56 of five electronic slot machine reels, 52V, 52W, 52X, 52Y and 54Z, 54V, 54W, 54X, 54Y and 54Z, and 56V, 56W, 56X, 56Y and 56Z. In the present example, each set 52, 54, 56 depicts three play locations, 52a, 52b, 52c; 54a, 54b, 54c; and 56a, 56b, and 56c, respectively. With respect to set 52, the center three reels, B, C, and D are spun to obtain a set of characters (in this case nine characters) in each play location space (i.e., a space where a symbol is located). The outer reels are left spinning. A set of mathematical values is obtained for achieving various combinations on each of the play locations, 52a, 52b, and 52c. The mathematical values are then used to determine symbols for each of the center three reels, B, C, and D in play locations 54a, 54b, and 54c, and 56a, 56b, and 56c. The remaining reels, A and D, stop spinning on each set and the player is credited according to a pay table. The betting may occur based on the above description with its numerous options.

While the invention has been described in detail and with reference to specific examples thereof, it will be apparent to one skilled in the art that various changes and modifications can be made therein without departing from the spirit and scope thereof.

What is claimed is:

1. A method of playing a card game, comprising the steps of:
(a) providing a plurality of card hand locations;
(b) betting at least one credit at at least one of the card hand locations;
(c) dealing a first hand of cards at a first of the card hand locations from a deck of cards;
(d) determining a mathematical value for the first hand of cards;
(e) dealing hands of cards at all remaining card hand locations, each hand having a mathematical value about equal to the mathematical value of the first hand; and
(f) crediting in accordance with a pay table associated with the value of each hand played.

2. The method of playing the card game of claim 1, including the step of providing a video display.

3. The method of playing the card game of claim 2, including the step of providing an initial screen that includes a plurality of selectable card games and the step of selecting one of the plurality of selectable card games for each of the card hand locations.

4. The method of playing the card game of claim 1, wherein the step of dealing includes dealing hands having cards from separate decks of cards.

5. The method of playing the card game of claim 1, including the step of holding and drawing cards for each selected card game prior to the step of crediting.

6. The method of playing the card game of claim 1, including the step of selecting at least one of the hands of cards for continued play subsequent to the step of dealing hands of cards at all remaining card hand locations.

7. The method of playing the card game of claim 6, including the step of moving the bet from at least one hand to the selected one or more hands.

8. The method of playing the card game of claim 5, including the steps of redealing at least one card from at least one of the first hand of cards and the second hand of cards, prior to the step of holding and drawing cards for each selected card game, and betting at least one additional credit, the amount of the at least one additional credit determined based on a new calculated mathematical value using the redealt at least one card.

9. The method of playing the card game of claim 5, including the steps of redealing at least one card from at least one of the first hand of cards and the second hand of cards, subsequent to the step of holding and drawing cards for each selected card game, and betting at least one additional credit, the amount of the at least one additional credit determined based on a new calculated mathematical value using the redealt at least one card.

10. The method of playing the card game of claim 5, including the step of crediting at least one hand in accordance with a pay table prior to the step of holding and drawing cards for each selected card game, wherein the crediting is based on the mathematical value of the first hand of cards.

11. A method of playing a card game, comprising the steps of:
(a) providing a plurality of card hand locations;
(b) betting at least one credit at at least one of the card hand locations;
(c) dealing a first hand of cards at a first of the card hand locations from a deck of cards;
(d) determining a mathematical value for the first hand of cards for each of a plurality of winning combinations;
(e) dealing hands of cards at all remaining card hand locations,
(f) determining a mathematical value for each hand at all remaining card hand locations for each of a plurality of winning combinations;
(g) assigning a potential award value to the first hand of cards for each type of winning combination;
(h) determining an award card factor for each type of winning combination in the first hand by multiplying the potential award value for each type of winning combination for the first hand of cards by the mathematical value for each type of winning combination for the first hand of cards;
(i) dividing the award card factor for each type of winning combination by the mathematical value for each type of winning combination associated with each remaining card hand location to determine a set of potential award values for each remaining card hand location which correspond to each type of winning combination;
(j) providing an award card table for each hand, the award card table listing the set of potential award values for each hand; and
(k) crediting in accordance with the award card table associated with the value of each hand played.

12. The method of playing the card game of claim 11, including the step of providing a video display.

13. The method of playing the card game of claim 12, including the step of providing an initial screen that includes a plurality of selectable card games and the step of selecting one of the plurality of selectable card games for each of the card hand locations.

14. The method of playing the card game of claim 11, wherein the step of dealing include dealing hands having cards from separate decks of cards.

15. The method of playing the card game of claim 11, including the step of holding and drawing cards for each selected card game after the step of providing an award card table.

16. The method of playing the card game of claim 11, including the step of selecting at least one of the hands of cards for continued play subsequent to the step of dealing hands of cards at all remaining card hand locations.

17. The method of playing the card game of claim 16, including the step of moving the bet from at least one hand to the selected one or more hands.

18. The method of playing the card game of claim 11, including the steps of redealing at least one card from at least one of the first hand of cards and the second hand of cards, prior to the step of holding and drawing cards for each selected card game, and betting at least one additional credit, the amount of the at least one additional credit determined based on a new calculated mathematical value using the redealt at least one card.

19. The method of playing the card game of claim 11, including the steps of redealing at least one card from at least one of the first hand of cards and the second hand of cards, subsequent to the step of holding and drawing cards for each selected card game, and betting at least one additional credit, the amount of the at least one additional credit determined based on a new calculated mathematical value using the redealt at least one card.

20. The method of playing the card game of claim 11, including the step of crediting at least one hand in accordance with a pay table prior to the step of holding and drawing cards for each selected card game, wherein the crediting is based on the mathematical value of the first hand of cards.

21. A method of playing a card game, comprising the steps of:
(a) providing a plurality of card hand locations;
(b) betting at least one credit at at least one of the card hand locations;
(c) dealing a first hand of cards at a first of the card hand locations from a deck of cards;
(d) determining a mathematical value for the first hand of cards for each of a plurality of winning combinations;
(e) dealing hands of cards at all remaining card hand locations,
(f) determining a mathematical value for each hand at all remaining card hand locations for each of a plurality of winning combinations; and
(g) crediting in accordance with a pay table associated with the value of each hand played such that the mathematical value of the first hand multiplied by an award for each winning combination in the first hand is equal to the mathematical value of each remaining hand times an award for each winning combination.

22. The method of playing the card game of claim 21, including the step of providing a video display.

23. The method of playing the card game of claim 22, including the step of providing an initial screen that includes a plurality of selectable card games and the step of selecting one of the plurality of selectable card games for each of the card hand locations.

24. The method of playing the card game of claim 21, wherein the step of dealing include dealing hands having cards from separate decks of cards.

25. The method of playing the card game of claim 21, including the step of holding and drawing cards for each selected card game.

26. The method of playing the card game of claim 21, including the step of selecting at least one of the hands of cards for continued play subsequent to the step of dealing hands of cards at all remaining card hand locations.

27. The method of playing the card game of claim 26, including the step of moving the bet from at least one hand to the selected one or more hands.

28. The method of playing the card game of claim 21, including the steps of redealing at least one card from at least one of the first hand of cards and the second hand of cards, prior to the step of holding and drawing cards for each selected card game, and betting at least one additional credit, the amount of the at least one additional credit determined based on a new calculated mathematical value using the redealt at least one card.

29. The method of playing the card game of claim 21, including the steps of redealing at least one card from at least one of the first hand of cards and the second hand of cards, subsequent to the step of holding and drawing cards for each selected card game, and betting at least one additional credit, the amount of the at least one additional credit determined based on a new calculated mathematical value using the redealt at least one card.

30. The method of playing the card game of claim 21, including the step of crediting at least one hand in accordance with a pay table prior to the step of holding and drawing cards for each selected card game, wherein the crediting is based on the mathematical value of the first hand of cards.

31. A method of playing a card game, comprising the steps of:
(a) providing a video display;
(b) providing an initial screen that includes a plurality of selectable card games;
(c) providing a game screen that includes a plurality of hand locations;
(d) selecting one of the plurality of selectable card games for each of the card hand locations;
(e) betting at least one credit at at least one of the card hand locations;
(f) dealing a first hand of cards at a first of the card hand locations from a deck of cards;
(g) determining a mathematical value for the first hand of cards;
(h) dealing hands of cards at all remaining card hand locations, each hand having a mathematical value about equal to the mathematical value of the first hand;
(i) holding and drawing cards in accordance with each selected card game; and
(j) crediting in accordance with a pay table associated with the value of each hand played.

32. The method of claim 31, including the step of selecting one or more of the hands of cards to continue play, and moving the bet from each hand to the selected one or more hands.

33. The method of playing the card game of claim 31, wherein the step of dealing include dealing hands having cards from separate decks of cards.

34. A method of playing a card game, comprising the steps of:
(a) providing a video display;
(b) providing an initial screen that includes a plurality of selectable card games;
(c) providing a game screen that includes a plurality of hand locations;
(d) selecting one of the plurality of selectable card games for each of the card hand locations;
(e) betting at least one credit at at least one of the card hand locations;
(f) dealing a first hand of cards at a first of the card hand locations from a deck of cards;
(g) determining a mathematical value for the first hand of cards for each of a plurality of winning combinations;
(h) dealing hands of cards at all remaining card hand locations,
(i) determining a mathematical value for each hand at all remaining card hand locations for each of a plurality of winning combinations;
(j) assigning a potential award value to the first hand of cards for each type of winning combination;
(k) determining an award card factor for each type of winning combination in the first hand by multiplying the potential award value for each type of winning combination for the first hand of cards by the mathematical value for each type of winning combination for the first hand of cards;
(l) dividing the award card factor for each type of winning combination by the mathematical value for each type of winning combination associated with each remaining card hand location to determine a set of potential award values for each remaining card hand location which correspond to each type of winning combination;
(m) providing an award card table for each hand, the award card table listing the set of potential award values for each hand; and
(n) crediting in accordance with the award card table associated with the value of each hand played.

35. The method of claim 34, including the step of selecting one or more of the hands of cards to continue play, and moving the bet from each hand to the selected one or more hands.

36. The method of playing the card game of claim 34, wherein the step of dealing include dealing hands having cards from separate decks of cards.

37. A method of playing a card game, comprising the steps of:
(a) providing a video display;
(b) providing an initial screen that includes a plurality of selectable card games;
(c) providing a game screen that includes a plurality of hand locations;
(d) selecting one of the plurality of selectable card games for each of the card hand locations;
(e) betting at least one credit at at least one of the card hand locations;
(f) dealing a first hand of cards at a first of the card hand locations from a deck of cards;
(g) determining a mathematical value for the first hand of cards for each of a plurality of winning combinations;
(h) dealing hands of cards at all remaining card hand locations;
(i) determining a mathematical value for each hand at all remaining card hand locations for each of a plurality of winning combinations; and
(j) crediting in accordance with a pay table associated with the value of each hand played such that the mathematical value of the first hand multiplied by an award for each winning combination in the first hand is equal to the mathematical value of each remaining hand times an award for each winning combination.

38. The method of claim 37, including the step of selecting one or more of the hands of cards to continue play, and moving the bet from each hand to the selected one or more hands.

39. The method of playing the card game of claim 37, wherein the step of dealing include dealing hands having cards from separate decks of cards.

40. A method of playing a card game, comprising the steps of:
(a) providing a plurality of card hand locations;
(b) betting at least one credit at at least one of the card hand locations;
(c) dealing hands of cards at each card hand location;
(d) selecting at least one hand of cards for continued play;
(e) holding and drawing cards for each card game selected for continued play; and
(f) crediting in accordance with a pay table associated with the value of each hand played.

41. The method of playing the card game of claim 40, including the step of providing a video display.

42. The method of playing the card game of claim 41, including the step of providing an initial screen that includes a plurality of selectable card games and the step of selecting one of the plurality of selectable card games for each of the card hand locations.

43. The method of playing the card game of claim 40, wherein the step of dealing includes dealing hands having cards from separate decks of cards.

44. A method of playing a game comprising the steps of:
(a) providing a plurality of first symbols and a plurality of second symbols;
(b) providing a first play location having a plurality of first play location spaces for displaying a subset of the first symbols and a second play location having a plurality of second play location spaces for displaying a subset of the second symbols;
(c) betting at least one credit at at least one of the first play location and the second play location;
(d) randomly assigning and displaying one symbol of the first symbols to a plurality of the first play location spaces, but not to all of the first location spaces;
(e) determining a mathematical value based on the randomly assigned and displayed symbols that is based on odds of achieving a specific subset of symbols of the first symbols when every first play location space is assigned and displayed one of the first symbols;
(f) assigning and displaying one symbol of the second symbols to a plurality of the second play location spaces, but not to all of the second location spaces, wherein the mathematical value of the assigned and displayed second symbols is substantially the same as the mathematical value of the randomly assigned and displayed first symbols;
(g) randomly assigning and displaying first symbols in each first play location space that has not yet been assigned and displayed one of the first symbols and randomly assigning and displaying second symbols in each second play location spaces that has not yet been assigned and displayed one of the second symbols; and
(h) crediting in accordance with a pay table associated with the value of the subset of symbols for each play location.

45. The method of playing the game of claim 44, including the step of selecting one of a plurality of selectable games for each of the play locations.

46. The method of playing the game of claim 44, including the step of selecting at least one of the play locations for continued play subsequent to the step of assigning and displaying one symbol of the second symbols to a plurality of the second play location spaces, but not to all of the second location spaces.

47. The method of playing the game of claim 46, including the step of moving and combining a bet from the first play location to the second play location.

48. The method of playing the game of claim 44, including the steps of randomly assigning and displaying at least one symbol from at least one of the first play location and the second play location a second time, prior to the step of randomly assigning and displaying first symbols in each first play location space that has not yet been assigned and displayed, and betting at least one additional credit, the amount of the at least one additional credit determined based on a new calculated mathematical value using the second randomly assigned and displayed symbol.

49. The method of playing the game of claim 44, including the steps of randomly assigning and displaying at least one symbol from at least one of the first play location and the second play location a second time, subsequent to the step of randomly assigning and displaying first symbols in each first play location space that has not yet been assigned and displayed one of the first symbols, the amount of the at least one additional credit determined based on a new calculated mathematical value using the second randomly assigned and displayed symbol.

50. The method of playing the game of claim 44, including the step of crediting at least one hand in accordance with a pay table prior to the step of randomly assigning and displaying first symbols in each first play location space that has not yet been assigned and displayed one of the first symbols, wherein the crediting is based on the mathematical value.

51. A method of playing a game comprising the steps of:
(a) providing a plurality of first symbols and a plurality of second symbols;
(b) providing a first play location having a plurality of first play location spaces for displaying a subset of the first symbols and a second play location having a plurality of second play location spaces for displaying a subset of the second symbols;
(c) betting at least one credit at at least one of the first play location and the second play location;
(d) randomly assigning and displaying one symbol of the first symbols to a plurality of the first play location spaces, but not to all of the first location spaces;
(e) determining a first mathematical value based on the randomly assigned and displayed symbols that is based on odds of achieving a specific subset of symbols of the first symbols when every first play location space is assigned and displayed one of the first symbols;
(f) randomly assigning and displaying one symbol of the second symbols to a plurality of the second play location spaces, but not to all of the second location spaces;
(g) determining a second mathematical value based on the randomly assigned and displayed second symbols that is based on odds of achieving a specific subset of symbols of the second symbols when every first play location space is assigned and displays one of the second symbols;
(h) randomly assigning and displaying first symbols in each first play location space that has not yet been assigned and displayed one of the first symbols and randomly assigning and displaying second symbols in each second play location spaces that has not yet been assigned and displayed one of the second symbols;
(i) assigning a potential award value to the first play location for a winning combination;
(j) determining an award card factor for the winning combination by multiplying the potential award value by the first mathematical value;
(k) dividing the award card factor by the second mathematical value to determine a potential award value for the second play location;
(l) crediting in accordance with a pay table associated with the value of the subset of symbols for each play location.

52. The method of playing the game of claim 51, including the step of selecting one of a plurality of selectable games for each of the play locations.

53. The method of playing the game of claim 51, including the step of selecting at least one of the play locations for continued play subsequent to the step of assigning and displaying one symbol of the second symbols to a plurality of the second play location spaces, but not to all of the second location spaces.

54. The method of playing the game of claim 53, including the step of moving and combining the bet from the first play location to the second play location.

55. The method of playing the game of claim 51, including the steps of randomly assigning and displaying at least one symbol from at least one of the first play location and the second play location a second time, prior to the step of randomly assigning and displaying first symbols in each first play location space that has not yet been assigned and displayed, and betting at least one additional credit, the amount of the at least one additional credit determined based on a new calculated mathematical value using the second randomly assigned and displayed symbol.

56. The method of playing the game of claim 51, including the steps of randomly assigning and displaying at least one symbol from at least one of the first play location and the second play location a second time, subsequent to the step of randomly assigning and displaying first symbols in each first play location space that has not yet been assigned and displayed one of the first symbols, the amount of the at least one additional credit determined based on a new calculated mathematical value using the second randomly assigned and displayed symbol.

57. A method of playing a game comprising the steps of:
(a) providing a plurality of first symbols and a plurality of second symbols;
(b) providing a first play location having a plurality of first play location spaces for displaying a subset of the first symbols and a second play location having a plurality of second play location spaces for displaying a subset of the second symbols;
(c) betting at least one credit at at least one of the first play location and the second play location;
(d) randomly assigning and displaying one symbol of the first symbols to a plurality of the first play location spaces;
(e) determining a mathematical value based on the randomly assigned and displayed symbols that is based on odds of achieving a specific subset of symbols of the first symbols when every first play location space is assigned and displayed one of the first symbols; and
(f) assigning and displaying one symbol of the second symbols to a plurality of the second play location spaces, wherein the mathematical value of the assigned and displayed second symbols is substantially the same as the mathematical value of the randomly assigned and displayed first symbols.

58. The method of playing the game of claim 57, including the step of selecting one of a plurality of selectable games for each of the play locations.

59. The method of playing the game of claim 57, including the step of selecting at least one of the play locations for continued play subsequent to the step of assigning and displaying one symbol of the second symbols to a plurality of the second play location spaces.

60. The method of playing the game of claim 57, including the step of moving and combining a bet from the first play location to the second play location.

61. The method of playing the game of claim 44, including the step of crediting at least one hand in accordance with a pay table.

62. A method of playing a game comprising the steps of:
(a) providing a plurality of first symbols and a plurality of second symbols;
(b) providing a first play location having a plurality of first play location spaces for displaying a subset of the first symbols and a second play location having a plurality of second play location spaces for displaying a subset of the second symbols;
(c) betting at least one credit at at least one of the first play location and the second play location;
(d) randomly assigning and displaying one symbol of the first symbols to a plurality of the first play location spaces;
(e) determining a first mathematical value based on the randomly assigned and displayed symbols that is based on odds of achieving a specific subset of symbols of the first symbols;
(f) randomly assigning and displaying one symbol of the second symbols to a plurality of the second play location spaces;
(g) determining a second mathematical value based on the randomly assigned and displayed second symbols that is based on odds of achieving a specific subset of symbols of the second symbols;
(h) assigning a potential award value to the first play location for a winning combination;
(i) determining an award card factor for the winning combination by multiplying the potential award value by the first mathematical value; and
(j) dividing the award card factor by the second mathematical value to determine a potential award value for the second play location.

63. The method of playing the game of claim 62, including the step of selecting one of a plurality of selectable games for each of the play locations.

64. The method of playing the game of claim 62, including the step of selecting at least one of the play locations for continued play subsequent to the step of assigning and displaying one symbol of the second symbols to a plurality of the second play location spaces.

65. The method of playing the game of claim 62, including the step of moving and combining the bet from the first play location to the second play location.
